(19) United States
(12) Patent Application Publication
(10) Pub. No.: US 2012/0034574 A1
(43) Pub. Date: Feb. 9, 2012

(54) DENTAL IMPLANT SYSTEM AND METHOD

(76) Inventor: DAN ROSEN, Calabasas, CA (US)

(21) Appl. No.: 12/851,406

(22) Filed: Aug. 5, 2010

(51) Int. Cl. A61C 8/00; A61C 19/04

(52) U.S. Cl. 433/75; 433/174

(57) ABSTRACT

A dental implant system and method for inserting a threaded implant in both edentulous and partially edentulous space of a patient's jaw bone in the form of a threaded implant having at least one hole adapted along its longitudinal axis for insertion of an abutment post and a drilling gauge having leg portions adapted for use with the implant. Any one of the leg portions includes a hole equally aligned with thee hole of the threaded implant when placed proximate the gauge. The implant is inserted into the hole drilled in the jaw bone. The hole of the drilling guage marks the location where a hole will be drilled vertically into the jaw bone through which an abutment post would be inserted and screwed into the hole of the implant, for subsequent placement of a prosthetic tooth.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to dental implant systems, and more particularly, to a system and method for inserting an elongated threaded dental implant in both edentulous and partially edentulous space of a patient's jaw bone.

Dental implants are fixtures, preferably of titanium, which are surgically screwed into a jaw bone. The implant is an anchor for a naturally appearing false tooth or a set of false teeth. The success rate of dental implants depends on where the implants are placed and their purpose. Typically, they are best placed in the front portion of a lower jaw. Implants are of great use for replacing missing teeth. Implants are not only used to replace one tooth, but also a set of teeth in a row. In addition, implants are increasingly being used to replace certain types of bridges and removable partial dentures. The latest and most advanced technology makes it possible to have teeth in a mouth that look like original teeth even though they are really replacements.

Several dental implants have been developed in the art for assisting users in replacing a tooth or a set of teeth. One such prior art directs to U.S. Pat. No. 3,981,079 by Lenczycki that discloses a dental implant for maintaining a dental prosthetic device in a fixed relation with respect to a jaw bone where a support post in the form of an internally threaded hollow cylindrical sleeve is provided. The support post is introduced into a complementary cavity formed in the region of the crest of the jaw bone. The support post is provided with at least partially threaded apertures that are spaced from each other along and angularly displaced from each other about the periphery of the support post. Self-tapping anchoring screws extend through preformed blind holes drilled in the jaw bone with the assistance of a jig forming part of the present invention. The preformed holes extend in a direction substantially normal to the support post and are aligned with the apertures in the latter. The anchoring screws threadedly engage the bone and the threaded portions of the support post without extending beyond the preformed blind holes. In this manner, the anchoring screws anchor and stabilize the support post in the jaw bone. The support post has a free end externally accessible in the region of the crest of the jaw bone for mounting a prosthetic device thereon. A jig and method of mounting the implant in the jaw bone is also described.

U.S. Pat. No. 4,802,847 by Komatsu discloses a dental implant that includes a wavy or tortuous body. The body with a tortuous cross section has ridges extending from an upper end to a lower end. The dental implant also has a head supported on the upper end of the body and adapted to fit into an artificial tooth.

U.S. Pat. No. 5,035,619 issued to Daftary discloses a system and method provided for implanting tooth analogues in the jaw bone resulting in aesthetically and functionally desirable gingival tissue contours after restoration. The system permits modification and adaptation of the tooth analogue to meet intraoral demands in a manner similar to that used in the preparation and restoration of natural teeth. The system comprises a standard fixture and cover screw passed through opened gingival tissue and implanted in the jaw bone. After the osseointegration of the fixture, the gingiva is reopened, the cover screw removed and a healing cap having a predetermined contour, is attached to the fixture. The reopened gingiva re-heals in a shape determined by the contour of the healing cap. The healing cap is then removed and replaced by an abutment having an emergence profile matching that of the healing cap. An immediate snug fit between the gingival tissues and the abutment is thereby provided at the time of connection of the abutment to the fixture. A crown is removably attached to the abutment by a screw extending through the side of the crown into the abutment.

All of the systems and methods for providing a dental implant discussed above have considerable drawbacks. Certain conventional dental implants cannot be inserted when there is insufficient jaw bone for the post to be inserted. Since bone grafting is required for the implantation, such methods are time consuming and require additional surgery, which is expensive. Some of the conventional methods require the insertion of two or more implants, which may not be an effective solution for people who do not recover quickly or are unable to deal with varying degrees of pain. In some dental implant systems, the abutment post and implant are not firmly engaged since the drilled hole is not correctly aligned with the hole of the implant. This may result in a loose joint, possibly causing a jaw fracture, due to unstable implantation.

Therefore, an object of the present invention is to provide a method and system for inserting an elongated threaded implant in both edentulous and partially edentulous space of a patient's jaw bone. One object of the invention is that the system does not require additional surgery and is economical. Another object of the invention is that the system includes a drilling guage as a guide to determine the location of the holes of the implant for screwing the abutment post acting as a healing cap over the hole drilled in the jaw bone to achieve more stability. Yet another object of the invention is that the system can be implanted immediately without waiting for the grafting of bone. Other objects of the present invention will become better understood with reference to appended Summary, Description and Claims.

### SUMMARY

The present invention is a system and method for inserting an elongated threaded dental implant in both edentulous and partially edentulous space of a patient's jaw bone for insertion of a set of prosthetic teeth or a shortened threaded dental implant for insertion of one prosthetic tooth. The dental implant system comprises a threaded implant having at least one hole adapted to fit with a hole drilled in the jaw bone and a drilling gauge having a plurality of leg portions adapted for use with the threaded implant, any one of the plurality of leg portions includes at least one hole that are equally aligned with the hole of threaded implant when placed proximate the drilling gauge. The threaded implant is inserted into the hole drilled in the jaw bone. The hole of the drilling gauge marks the place where a hole will be drilled vertically into the jaw bone for insertion of the abutment post that will be inserted into the hole of the jaw bone and screwed into the hole of the threaded implant. The gum flaps are sutured around the abutment post to hermetic closure. A prosthetic tooth is then affixed onto the abutment post.

The abutment post may be a bowl attachment, anchor attachment, era attachment, locator attachment, pre fabricated dolder bar and any other commercially available attachments. The drilling guage is adapted to use as a guide to determine the hole of the threaded implant. The threaded implant is removably attached to the drilling guage. At least one of the plurality of leg portions may be a short lateral leg portion and another one of the plurality of leg portions may be an elongated leg portion.

The method of anchoring a threaded implant in an edentulous space of a patient's jaw bone will require an elongated threaded implant for insertion of several teeth, and includes the following steps. Initially, gum flaps over the jaw bone in the middle of the crest around an arch is cut and opened. Four vertical incisions are placed in a second molar area and a cuspid area. The gum flaps on a buccal side and a lingual side are reflected to expose the jaw bone. The cuspid area in the jaw bone is marked with a round burr to drill holes. A hole is formed by extracting 1.5-2 mm diameter of jaw bone based on the size of the elongated threaded implant by drilling horizontally and parallel to the top of a ridge of the arch using a 2 mm twist drill. The length of the hole drilled is equal to the length of the elongated threaded implant to be inserted. The drilling is continued to extract 3.5 mm diameter of jaw bone to enlarge the diameter of the hole to slightly less than the diameter of the elongated threaded implant to be inserted. The hole is rinsed with a syringe of saline to remove debris. The elongated threaded implant is inserted into the hole drilled in the jaw bone and the elongated threaded implant is moved to a desired length.

A marking line marked on a head portion of the elongated threaded implant is adjusted to the direction that points toward the holes of the elongated threaded implant. A short lateral leg portion of the drilling guage is placed on the head portion of the elongated threaded implant. At least one hole on the elongated leg portion of the drilling gauge is equally aligned with at least one hole on the elongated threaded implant. The jaw bone is drilled vertically using a 2 mm burr to clear the bone above the at least one hole on the elongated threaded implant. Here, the drilling gauge is used as a guide to determine the at least one hole on the elongated threaded implant for drilling the hole in the jaw bone. The drilling gauge is removed and a non-cutting edge countersync drill is used to clean the remaining bone around the elongated threaded implant. Then, the hole is rinsed with a syringe of saline to remove the debris. At least one abutment post is screwed into the at least one hole on the elongated threaded implant and the gum flaps are sutured around the abutment post to hermetic closure. A prosthetic tooth is then affixed to the abutment post.

The dental implant system can also be implanted in partially edentulous space of a patient's jaw bone. In this case, a shortened threaded implant may be used for the insertion of only one prosthetic tooth. The shortened threaded implant may be of any desirable size to hold a single tooth or more than one tooth. The method of anchoring the shortened threaded implant in a partially edentulous space of a patient's jaw bone includes the following steps. Initially, gum flaps around the desired partially edentulous space are opened. Vertical incisions are made and the gum flaps on a buccal side and a lingual side is reflected to expose the jaw bone. The buccal side of the jaw bone is marked with a round burr to drill holes. A hole is formed by drilling horizontally using a 2 mm twist drill from the buccal side to lingual side. The drilling is continued to enlarge the diameter of the hole based on the size of the diameter of the shortened threaded implant to be inserted. The shortened threaded implant is inserted into the hole drilled in the jaw bone.

A marking line marked on a head portion of the shortened threaded implant is adjusted to the direction that points toward the hole of the threaded implant. An elongated leg portion of the drilling guage is placed on the head portion of the shortened threaded implant. At least one hole on the short lateral leg portion of the drilling gauge is equally aligned with at least one hole on the shortened threaded implant. The jaw bone is drilled vertically using a 1.8 mm burr to clear the bone above the at least one hole on the shortened threaded implant. Here, the drilling gauge is used as a guide to determine the location of the at least one hole on the shortened threaded implant for drilling the hole into the jaw bone. The drilling gauge is removed and a non-cutting edge countersync drill is used to clean the remaining bone around the elongated threaded implant. Then, the hole is rinsed with a syringe of saline to remove the debris. At least one abutment post is screwed into the at least one hole on the shortened threaded implant and the gum flaps are sutured above the abutment post. A prosthetic tooth is then affixed onto the abutment post.

### BRIEF DESCRIPTION OF THE FIGURES

FIG. 1 is a perspective view of the present invention, illustrating a dental implant system implantable in edentulous space of a patient's jaw bone.

FIG. 2 is a front perspective view of a jaw bone having holes in the middle of the crest around an arch for insertion of an elongated threaded implant.

FIG. 3 is a perspective view of the present invention, illustrating a head portion of the elongated threaded implant that connected to a short lateral leg portion of the drilling gauge.

FIG. 4 is a perspective view of the elongated leg portion of the drilling gauge with at least one hole that aligned with at least one hole on the elongated threaded implant when placed proximate the drilling gauge.

FIG. 5 is a perspective view of the dental implant system with a shortened threaded implant implantable in partially edentulous space of a patient's jaw bone.

FIG. 6 is a perspective view of the present invention, illustrating a method of connecting a head portion of the elongated threaded implant to an elongated leg portion of the drilling gauge. Here, a shortened threaded implant is used as an example.

FIG. 7 is a perspective view of the present invention, illustrating a head portion of the shortened threaded implant that is connected to the elongated leg portion of the drilling gauge.

FIG. 8 is a top perspective view of the jaw bone with the insertion of a plurality of abutment posts. It shows the place for insertion of both the elongated threaded implant with two holes and the shortened threaded implant (for one hole). The shortened threaded implant is inserted laterally.

FIG. 9 is a flowchart illustrating a method of anchoring an elongated threaded implant in an edentulous space of a patient's jaw bone.

FIG. 10 is a flowchart illustrating method of anchoring an elongated threaded implant in a partially edentulous space of a patient's jaw bone.

### REFERENCE NUMERALS

10 . . . Dental implant system

12 . . . Elongated threaded implant

14 . . . Head portion of the elongated threaded implant

16 . . . At least one hole on the elongated threaded implant

18 . . . Drilling gauge

20 . . . Short lateral leg portion

22 . . . Elongated leg portion

24 . . . At least one hole of the drilling gauge

26 . . . At least one abutment post

28 . . . Jaw bone

30 . . . Hole drilled in the jaw bone

32 . . . Gum flaps over the jaw bone

34 . . . Marking line

40 . . . Flowchart illustrating a method of anchoring an elongated threaded implant in an edentulous space of a patient's jaw bone

42 . . . Cutting gum flaps over the jaw bone in the middle of the crest around an arch

44 . . . Placing four vertical incisions in a second molar area and a cuspid area

46 . . . Reflecting the gum flaps on a buccal side and a lingual side to expose the jaw bone

48 . . . Marking the jaw bone with a round bur in the cuspid area

50 . . . Extracting 1.5-2 mm diameter of jaw bone to form a hole

52 . . . Extracting the next drill of 3.5 mm diameter of jaw bone to enlarge the diameter of the hole

54 . . . Rinsing the hole with a syringe of saline to remove debris

56 . . . Inserting the elongated threaded implant into the hole drilled in the jaw bone

58 . . . Placing the marking line marked on a head portion of the elongated threaded implant to point toward a center of the ridge

60 . . . Placing a short lateral leg portion of the drilling gauge to the head portion of the elongated threaded implant

62 . . . Aligning at least one hole on the elongated leg portion of the drilling gauge with at least one hole on the elongated threaded implant

64 . . . Drilling vertically using a 2 mm burr to clear the bone above the at least one hole on the elongated threaded implant

66 . . . Removing the drilling gauge and taking a non-cutting edge countersync drill to clean the remaining bone around the elongated threaded implant

68 . . . Rinsing with a syringe of saline to remove the debris

70 . . . Screwing at least one abutment post into the at least one hole on the elongated threaded implant

72 . . . Placing an impression of tooth formed as a cast arch and then suturing the gum flaps above the cast arch

80 . . . Flowchart illustrating a method of anchoring an elongated threaded implant in a partially edentulous space of a patient's jaw bone

82 . . . Opening gum flaps around the desired partially edentulous space

84 . . . Placing vertical incisions and reflecting the gum flaps on a buccal side and a lingual side to expose the jaw bone

86 . . . Marking the jaw bone with a round burr in the buccal side

88 . . . Drilling horizontally using a 2 mm twist drill from the buccal side to lingual side to form a hole on the jaw bone

90 . . . Enlarging the diameter of the hole based on the size of the elongated threaded implant to be inserted

92 . . . Inserting the elongated threaded implant into the hole drilled on the jaw bone

94 . . . Placing the marking line marked on head portion of the elongated threaded implant to point toward the hole

96 . . . Placing an elongated leg portion of the drilling guage to the head portion of the elongated threaded implant

98 . . . Aligning at least one hole on the short lateral leg portion of the drilling gauge with at least one hole on the elongated threaded implant

100 . . . Drilling vertically using a 1.8 mm burr to clear the bone above the at least one hole on the elongated threaded implant

102 . . . Removing the drilling gauge and taking a non-cutting edge countersync drill to clean the remaining bone around the elongated threaded implant

104 . . . Rinsing the syringe of saline to remove the debris

106 . . . Screwing at least one abutment post into the at least one hole on the elongated threaded implant

108 . . . Placing an impression of tooth on the at least one abutment post and then suturing the gum flaps above the impression of tooth

### DETAILED DESCRIPTION

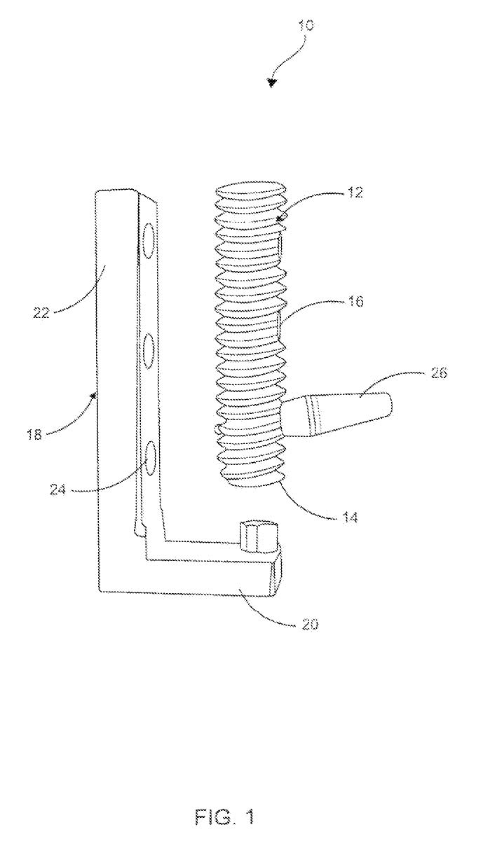

Referring to the drawings, a preferred embodiment illustrates a dental implant system 10 and method for inserting an elongated threaded dental implant 12 in both edentulous and partially edentulous space of a patient's jaw bone 28 and generally indicated in FIGS. 1 through 10. Referring now to FIG. 1, the dental implant system 10 that can be implanted in the edentulous space of a patient's jaw bone 28 is illustrated. The dental implant system 10 comprises an elongated threaded implant 12 having at least one hole 16 adapted for insertion in a hole drilled in the jaw bone 30 and a drilling gauge 18 having a plurality of leg portions adapted for use with the elongated threaded implant 12, any one of the plurality of leg portions includes at least one hole 24 that equally aligned with the hole of the elongated threaded implant 16 when placed proximate the drilling gauge 18. The system 10 further includes at least one abutment post 26 for securing the elongated threaded implant 12 to the jaw bone 28. The elongated threaded implant 12 is inserted into the hole drilled in the jaw bone 30 and the abutment post 26 is screwed into the hole of the elongated threaded implant 16 thereby acts as a healing cap over the hole drilled in the jaw bone 30 for achieving more stability.

The drilling guage 18 is adapted to use as a guide to determine the hole of the elongated threaded implant 16. The at least one of the plurality of leg portions may be a short lateral leg portion 20 and another one of the plurality of leg portions may be an elongated leg portion 22.

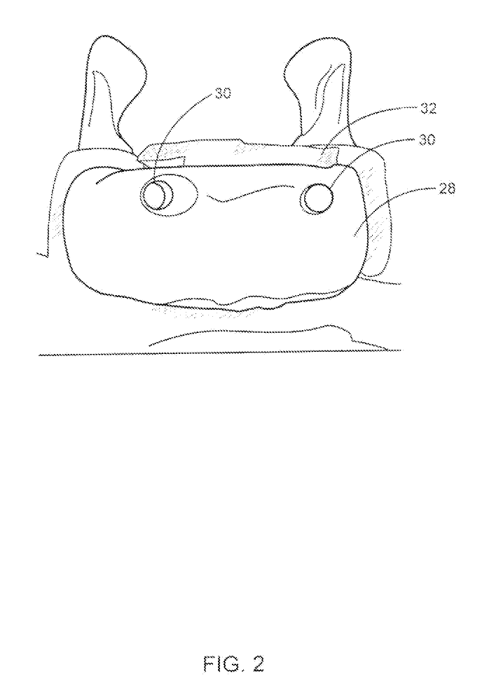

FIG. 2 is a front perspective view of a jaw bone 28 having the holes 30 in the middle of the crest around an arch. Initially, Qum flaps over the jaw bone 32 are cut and opened to expose the jaw bone 28 for drilling the holes 30 before inserting the elongated threaded implant 12.

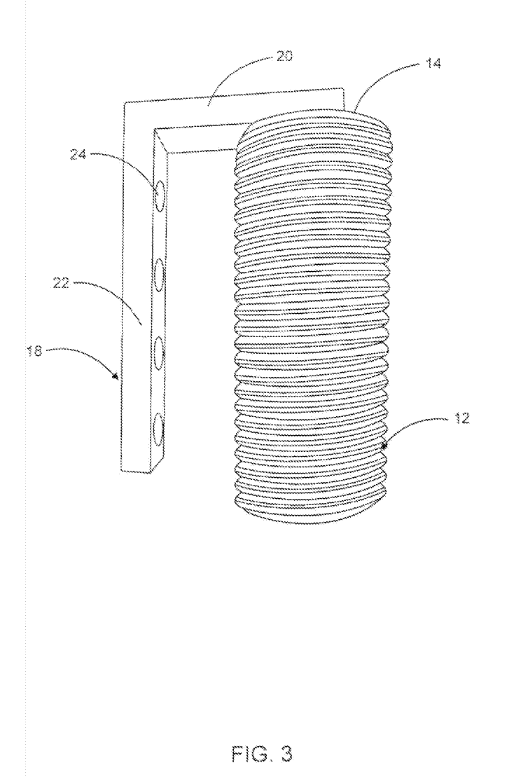

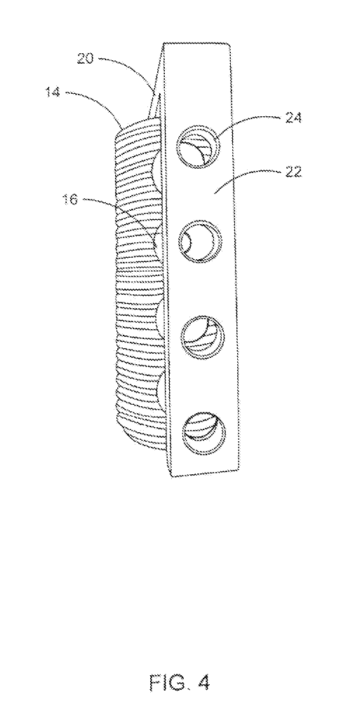

FIG. 3 is a perspective view of the present invention, illustrating a head portion of the elongated threaded implant 14 that is connected to a short lateral leg portion of the drilling gauge 20. The drilling guage 18 is removably attached to the elongated threaded implant 12. The elongated leg portion of the drilling gauge 22 includes the holes 24 that can be equally aligned with the holes of the elongated threaded implant 16. FIG. 4 is a perspective view of the elongated leg portion of the drilling gauge 22 with the holes 24 aligned with the holes on the elongated threaded implant 16 when placed proximate the drilling gauge 18.

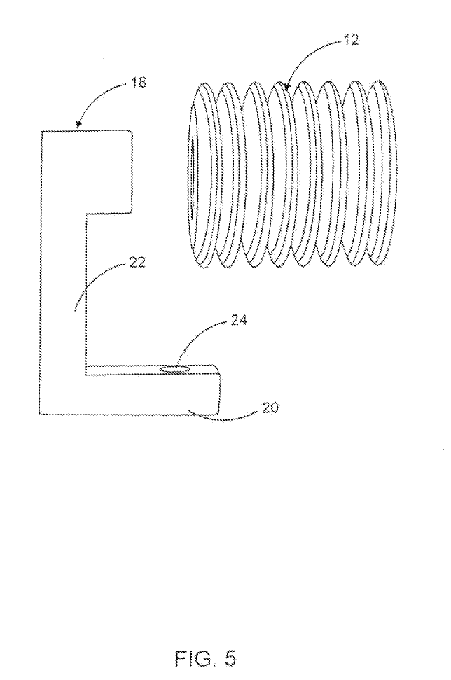

FIG. 5 is a perspective view of the dental implant system 10 implantable in a partially edentulous space of a patient's jaw bone 28. The short lateral leg portion of the drilling gauge 20 includes the holes 24 that can be equally aligned with the holes of the elongated threaded implant 16. The elongated threaded implant 12 may be of any desirable size to hold a single tooth or more than one tooth.

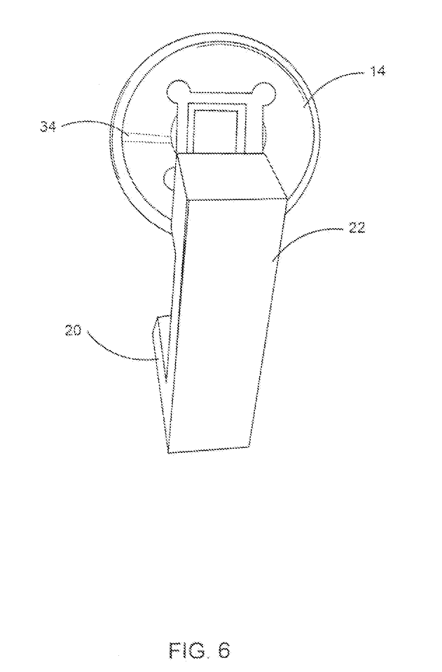

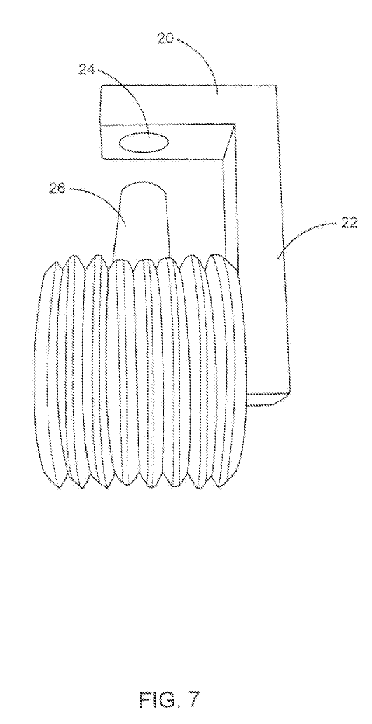

FIG. 6 is a perspective view of the present invention, illustrating a method of connecting a head portion of the elongated threaded implant 14 to an elongated leg portion of the drilling gauge 22. The elongated leg portion of the drilling guage 22 is inserted into the head portion of the elongated threaded implant 14 to move a marking line 34 in direction of place where the holes to be drilled in the jaw bone 30. FIG. 7 is a perspective view of the present invention, illustrating a head portion of the elongated threaded implant 14 that is connected to the elongated leg portion of the drilling gauge.

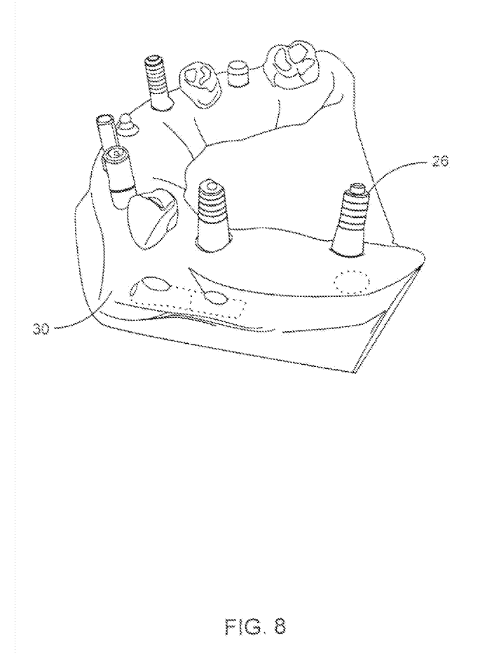

FIG. 8 is a top perspective view of the jaw bone 28 with the insertion of an abutment post 26. The abutment post 26 may be selected from a group consisting of a bowl attachment, anchor attachment, era attachment, locator attachment, pre fabricated dolder bar and any other commercially available attachments. An impression of the tooth is placed over the abutment post 26 and the gum flaps over the jaw bone 32 are sutured above the tooth.

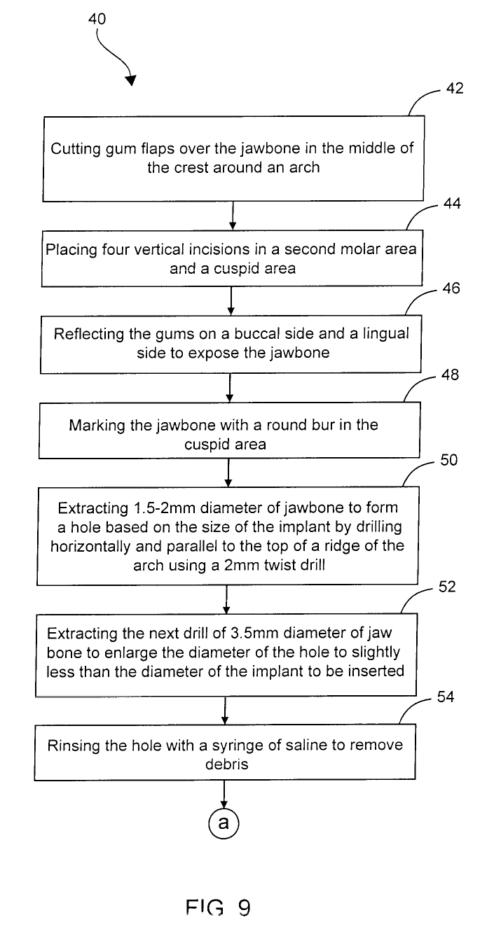

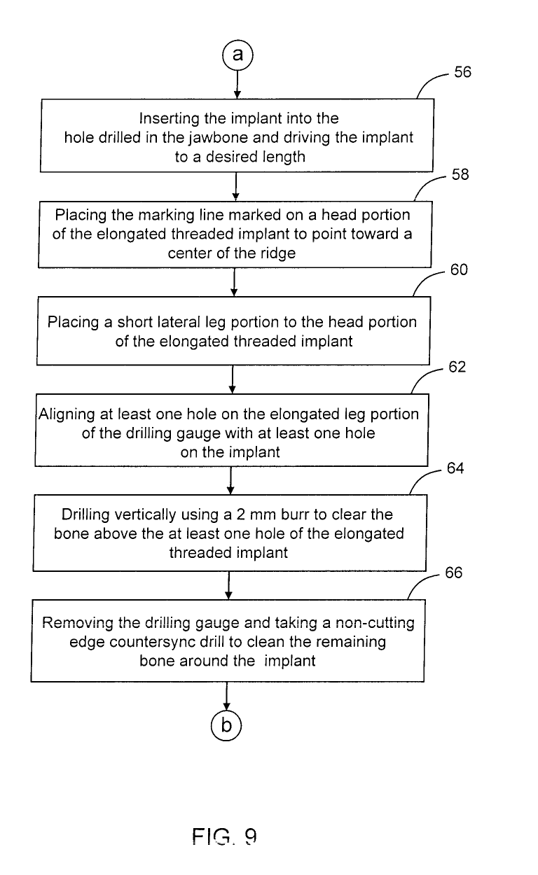

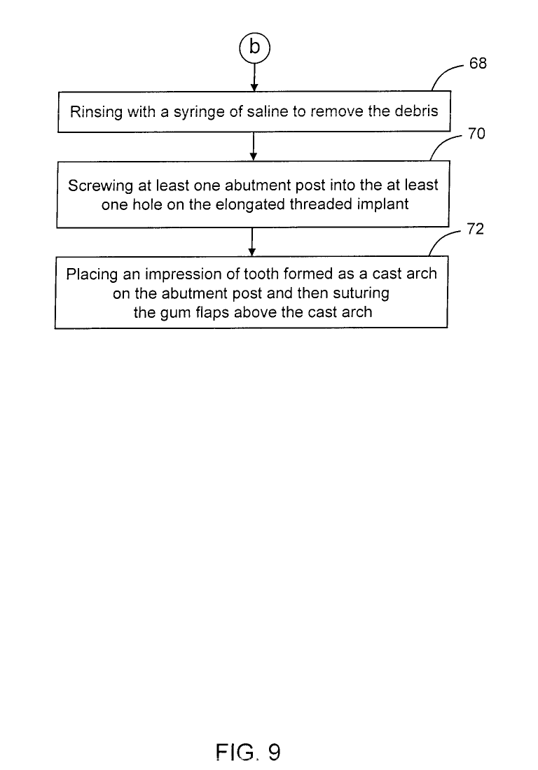

FIG. 9 is a flowchart illustrating a method of anchoring an elongated threaded implant in an edentulous space of a patient's jaw bone 40. Initially, gum flaps over the jaw bone in the middle of the crest around an arch is cut and opened as indicated at block 42. At block 44, four vertical incisions are placed in a second molar area and a cuspid area. The gum flaps on a buccal side and a lingual side are reflected to expose the jaw bone as indicted at block 46. The cuspid area in the jaw bone is marked with a round bur to drill holes as indicated at block 48. A hole is formed by extracting 1.5-2 mm diameter of jaw bone based on the size of the elongated threaded implant by drilling horizontally and parallel to the top of a ridge of the arch using a 2 mm twist drill as indicated at block 50. The length of the hole drilled is equal to the length of the elongated threaded implant to be inserted. The drilling is continued to extract 3.5 mm diameter of jaw bone to enlarge the diameter of the hole to slightly less than the diameter of the elongated threaded implant to be inserted as indicated at block 52. The hole is rinsed with a syringe of saline to remove debris as indicated at block 54. The elongated threaded implant is inserted into the hole drilled in the jaw bone and the elongated threaded implant is moved to a desired length as indicated at block 56.

A marking line marked on a head portion of the elongated threaded implant is adjusted to the direction that point toward a center of the ridge as indicated at block 58. A short lateral leg portion of the drilling guage is placed to the head portion of the elongated threaded implant as indicated at block 60. At least one hole on the elongated leg portion of the drilling gauge is equally aligned with at least one hole on the elongated threaded implant as indicated at block 62. The jaw bone is drilled vertically using a 2 mm burr to clear the bone above the at least one hole on the elongated threaded implant as indicated at block 64. Here, the drilling gauge is used as a guide to determine the at least one hole on the elongated threaded implant for drilling the hole in the jaw bone. The drilling gauge is removed and a non-cutting edge countersync drill is used to clean the remaining bone around the elongated threaded implant as indicated at block 66. Then, rinsing the hole with a syringe of saline to remove the debris as indicated at block 68. At least one abutment post is screwed into the at least one hole on the elongated threaded implant as indicated at block 70 and finally, an impression of tooth formed as a cast arch is placed on the at least one of abutment post and then the gum flaps are sutured above the cast arch as indicated at block 72.

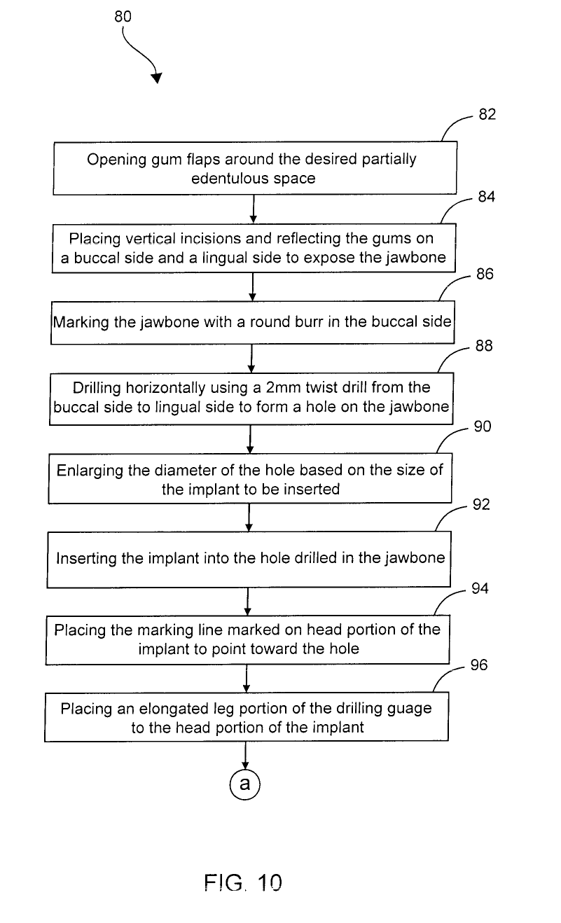

FIG. 10 is a flowchart illustrating a method of anchoring an elongated threaded implant in a partially edentulous space of a patient's jaw bone 80. Initially, gum flaps around the desired partially edentulous space are opened as indicated at block 82. At block 84, vertical incisions are placed and the gum flaps on a buccal side and a lingual side are reflected to expose the jaw bone. The buccal side of the jaw bone is marked with a round burr to drill holes as indicated at block 86. A hole is formed by drilling horizontally using a 2 mm twist drill from the buccal side to lingual side as indicated at block 88. The drilling is continued to enlarge the diameter of the hole based on the size of the diameter of the elongated threaded implant to be inserted as indicated at block 90. The elongated threaded implant is inserted into the hole drilled in the jaw bone as indicated at block 92.

A marking line marked on a head portion of the elongated threaded implant is adjusted to the direction that point toward the hole as indicated at block 94. An elongated leg portion of the drilling guage is placed to the head portion of the elongated threaded implant as indicated at block 96. At least one hole on the short lateral leg portion of the drilling gauge is equally aligned with at least one hole on the elongated threaded implant as indicated at block 98. The jaw bone is drilled vertically using a 1.8 mm burr to clear the bone above the at least one hole on the elongated threaded implant as indicated at block 100. Here, the drilling gauge is used as a guide to determine the at least one hole on the elongated threaded implant for drilling the hole in the jaw bone. The drilling gauge is removed and a non-cutting edge countersync drill is used to clean the remaining bone around the elongated threaded implant as indicated at block 102. Then, rinsing with a syringe of saline to remove the debris as indicated at block 104. At least one abutment post is screwed into the at least one hole on the elongated threaded implant as indicated at block 106 and finally, an impression of tooth formed is placed on the at least one of abutment post and then the gum flaps are sutured above the cast arch as indicated at block 108.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

1. A dental implant system implantable in both edentulous and partially edentulous space of a patient's jaw bone comprising:
an elongated threaded implant adapted for insertion in a hole drilled in the jaw bone having at least one hole along a longitudinal axis of the elongated threaded implant, the at least one hole adapted for insertion of an abutment post:
a drilling gauge having a plurality of leg portions adapted for use with the elongated threaded implant, any one of the plurality of leg portions includes at least one hole that equally align with the at least one hole on the elongated threaded implant when placed proximate the drilling gauge; and
at least one abutment post for securing the elongated threaded implant to the jaw bone and for insertion along the longitudinal axis of the elongated threaded implant.

2. The dental implant system of claim 1, wherein the drilling gauge is adapted to use as a guide to find the at least one hole on the elongated threaded implant.

3. The dental implant system of claim 1, wherein the drilling gauge is removably attached to the elongated threaded implant.

4. The dental implant system of claim 1, wherein at least one of the plurality of leg portions may be a short lateral leg portion,

5. The dental implant system of claim 1, wherein at least one of the plurality of leg portions may be an elongated leg portion.

6. The dental implant system of claim 1, wherein the at least one abutment post may be selected from a group consisting of a bowl attachment, anchor attachment, era attachment, locator attachment and pre fabricated dolder bar.

7. A method of anchoring an elongated threaded implant in an edentulous space of a patient's jaw bone, the method comprising the steps of:
(a) cutting gum flaps over the jaw bone in the middle of the crest around an arch;
(b) placing four vertical incisions in a second molar area and a cuspid area;
(c) reflecting the gum flaps on a buccal side and a lingual side to expose the jaw bone;
(d) marking the jaw bone with a round burr in the cuspid area;
(e) extracting 1.5-2 mm diameter of jaw bone to form a hole based on the size of the elongated threaded implant by drilling horizontally and parallel to the top of a ridge of the arch using a 2 mm twist drill, wherein the length of the hole is equal to the length of the elongated threaded implant to be inserted;
(f) extracting the next drill of 3.5 mm diameter of jaw bone to enlarge the diameter of the hole to slightly less than the diameter of the elongated threaded implant to be inserted;
(g) rinsing the hole with a syringe of saline to remove debris;
(h) inserting the elongated threaded implant into the hole drilled in the jaw bone and driving the elongated threaded implant to a desired length;
(i) placing the marking line marked on a had portion of the elongated threaded implant to point toward a center of the ridge:
(j) placing a short lateral leg portion of the drilling guage to the head portion of the elongated threaded implant,
(k) aligning at least one hole on the elongated leg portion of the drilling gauge with at least one hole on the elongated threaded implant;
(l) drilling vertically using a 2 mm burr to clear the bone above the at least one hole on the elongated threaded implant, using the drilling gauge as a guide to determine the location of the at least one hole on the elognated threaded implant;
(m) removing the drilling gauge and taking a non-cutting edge countersync drill to clean the remaining bone around the elongated threaded implant:
(n) rinsing with a syringe of saline to remove the debris;
(o) to screwing at least one abutment post into the at least one hole on the elongated threaded implant: and
(p) placing an impression of tooth formed as a cast arch on the at least one of abutment post and then suturing the gum flaps above the cast arch,

8. The method of claim 7, wherein the drilling gauge is adapted to use as a guide to determine the at least one hole on the elongated threaded implant.

9. The method of claim 7, wherein the drilling gauge is removably attached to the elongated threaded implant.

10. The method of claim 7, wherein the at least one abutment post may be selected from a group consisting of a bowl attachment, anchor attachment, era attachment, locator attachment and pre fabricated dolder bar.

11. A method of anchoring an elongated threaded implant in a partially edentulous space of a patient's jaw bone, The method comprising the steps of:
(a) opening gum flaps around the desired partially edentulous space on the jaw bone;
(b) placing vertical incisions and reflecting: the gum flaps on a buccal side and a lingual side to expose the jaw bone:
(c) marking the jaw bone with a round burr in the buccal side;
(d) drilling horizontally using a 2 mm twist drill from the buccal side to lingual side to form a hole on the jaw bone;
(e) enlarging the diameter of the hole based on the size of the elongated threaded implant to be inserted;
(f) inserting the elongated threaded implant into the hole drilled in the jaw bone;
(g) placing the marking line marked on head portion of the elongated threaded implant to point toward the hole;
(h) piecing an elongated leg portion of the drilling guage to the head portion of the elongated threaded implant,
(i) aligning at least one hole on the short lateral leg portion of the drilling guage with at least one hole on the elongated threaded implant;
(j) drilling vertically using a 1.8 mm burr to dear the bone above the at least one hole on the elongated threaded implant, using the drilling gauge as guide to determine the at least one hole on the elongated threaded implant;
(k) removing the drilling gauge and taking a non-cutting edge countersync drill to clean the remaining bone around the elongated threaded implant;
(l) rinsing with a syringe of saline to remove the debris;
(m) screwing at least one abutment post into the at least on hole on the elongated threaded implant; and
(n) placing an impression of tooth on the at least one abutment post and then suturing the gum flaps above the impression of tooth.

12. The method of claim 11, wherein the drilling gauge is adapted to use as a guide to determine the location of the at least one hole on the elongated threaded implant.

13. The method of claim 11, wherein the drilling gauge is removably attached to the elongated threaded implant

14. The method of claim 11, wherein the at least one abutment: post may be selected from a group consisting of a bowl attachment, anchor attachment, era attachment, locator attachment and pre-fabricated dolder bar.
